(19) United States
(12) Patent Application Publication
(10) Pub. No.: US 2025/0128195 A1
(43) Pub. Date: Apr. 24, 2025

(54) A BIODEGRADABLE FILTER ASSEMBLY FOR AN ELECTRICAL APPLIANCE

(71) Applicant: Dyson Technology Limited, Wiltshire (GB)

(72) Inventors: Nikian Naji AGHABABAIE, London (GB); Mark Niall O'RIORDAN, Bristol (GB); Laura Anne READ, Bristol (GB)

(21) Appl. No.: 18/689,131

(22) PCT Filed: Sep. 22, 2022
(86) PCT No.: PCT/GB2022/052390

§ 371 Date: Mar. 5, 2024

(30) Foreign Application Priority Data
Sep. 23, 2021 (GB) 2113555.3

(51) Int. Cl. B01D 46/00; B01D 39/16; B01D 46/56; B01D 53/04

(52) U.S. Cl. CPC B01D 46/0036; B01D 39/1623; B01D 46/56; B01D 53/0415; B01D 2239/025; B01D 2239/0266; B01D 2239/0428; B01D 2239/0435; B01D 2239/0478; B01D 2239/0622; B01D 2239/0631; B01D 2239/0654; B01D 2239/0668; B01D 2239/083; B01D 2253/102; B01D 2258/06

(57) ABSTRACT

A biodegradable filter assembly for an electrical appliance including a motor for generating an airflow through the appliance, in use, the biodegradable filter assembly being configured to filter particulate matter from the airflow, wherein the biodegradable filter assembly includes a filter medium and a filter frame for the filter medium, wherein both the filter frame and the filter medium contain at least 80% bio-based polymers which are compostable at the end of filter assembly service life.

The present invention relates to a serviceable part for an electrical appliance. Aspects of the invention relate to a serviceable part, a serviceable filter assembly and an electrical appliance. In particular, but not exclusively, the invention relates to a serviceable filter assembly for use in an electrical appliance, such as an air purification system or a vacuum cleaner.

Air purification systems (or air purifiers) generally use a compressor to take in air from the direct environment of the air purifier, one or more filters to remove unwelcome particles and other contaminants, and one or more nozzles from which to expel the filtered outgoing air. Depending on the application, the air may not just be filtered, but may also be cooled, heated, moisturised, dried, or otherwise treated, while it flows between the air inlet and an outlet of the air purifier. Particulate and chemical filters are the main mechanisms by which the air purifier removes fine particulates and gasses, which can be harmful to people, from the air.

Known filters for air purification systems can be designed to achieve a standard known as High Efficiency Particulate Air (HEPA) filters, defined in Europe as grade H13 to EN1822. This requires at least 99.95% of all particle sizes to be filtered from the airflows. In filters for wearable air purifiers, there may be a lower target of 99% of particles and other contaminants being filtered from the airflow.

For vacuum cleaner applications, the filters hold particles and other contaminants which, over time, build up to levels which affect filtration rate. The filter medium therefore needs to be washed regularly to ensure dust which becomes trapped within the filter medium is removed and the efficiency of filtration is restored. It is important that the structure of the filter medium is compatible with the washing requirements of the filter, and that repeated washing of the filter medium to refresh it does not degrade long-term filtration performance.

Conventional, high efficiency filter assemblies for air purifiers are not typically washable and may be made from glass or petrochemical based polymers. These filters are often made up of one or more different materials bonded together, making it extremely difficult or impossible to separate and recycle them at the end of their life. As a result, the most commonly accepted end of life options are landfill or incineration. Although landfill doesn't immediately contribute to global warming, it does foster a toxic environment and governments are eager to remove this as an option for municipal waste. Incineration recovers entrapped energy within the polymers, but for glass filters it only converts to molten glass and does not produce the desired energy returns. Furthermore, this option produces toxic pollutants, not all of which are filtered before entering the environment.

In other electrical appliances, such as floorcare applications, there is also a requirement to use HEPA filters which must be washed regularly and then eventually disposed of at the end of life. Again, there is a need to address the undesirable build-up of landfill and toxic pollutants which results.

Disposal of filter assemblies from electrical appliances such as air purifiers and vacuum cleaners remains a challenge and an alternative and more sustainable solution is sought to reduce the environmental impact on the consumable nature of filters. Moreover, any solution must ensure the filter structure itself retains a sufficiently high efficiency of filtration for the device to be feasible.

It is against this background that the present invention has been devised.

### SUMMARY OF THE INVENTION

According to a first aspect of the present invention there is provided a biodegradable filter assembly for an electrical appliance comprising a motor for generating an airflow through the appliance, in use, the biodegradable filter assembly being configured to filter particulate matter from the airflow, wherein the biodegradable filter assembly comprises a filter medium comprising at least 80% bio-based polymers which are compostable at the end of filter service life.

Reference to a bio-based material is one which has been made from a substance derived from a living or once-living organism, such as a plant, tree or animal. The material may have undergone physical, chemical or biological treatment since the organism was living.

The invention provides the advantage that, due to the high content of bio-based material within the filter assembly, the filter assembly is readily compostable at the end of service life. The filter assembly may, for example, comprise a filter frame, adhesives and fibre filter layers which all comprise at least 80% bio-based material. Further benefits of the invention are provided by the arrangement of fibre layers to form the filter medium, ensuring high efficiency of filtration. Additives may be applied or incorporated within the fibre layers to provide benefits for the life of the filter.

The bio-based polymers of the filter frame and of the filter medium are compostable through an anaerobic or aerobic domestic or industrial composting process.

The filter medium may comprise a multi-layer structure comprising a first, fibre layer and a second, membrane layer carried by the first fibre layer, and wherein the multi-layer structure comprises at least 80% bio-based polymers, preferably at least 85% bio-based polymers and more preferably at least 90% bio-based polymers.

The filter medium may comprise a plurality of multi-later structures each comprising a first, fibre layer and a second, membrane layer carried by the first fibre layer.

The multi-layer structure may comprise at least one further fibre layer to define a sandwich layer structure, with the membrane layer sandwiched between the first and further fibre layers, and wherein the further fibre layer comprises at least 80% bio-based polymers.

For example, the fibre structure may comprise at least one further membrane layer carried by one of the first fibre layer or the further fibre layer, and wherein the further membrane layer comprises at least 80% bio-based polymers.

The at least one further membrane layer may comprise at least 80% bio-based polymers, preferably at least 85% bio-based polymers and more preferably at least 90% bio-based polymers.

In some embodiments, the layers of the multi-layer structure are bonded together with a compostable chemical binder.

For example, the layers of the multi-layer structure may be thermally bonded together.

The biodegradable filter assembly may further comprise an additional fibre layer. The additional fibre layer may be thicker than the multi-layer structure.

The additional fibre layer and the multi-layer structure may be bonded together with a compostable chemical binder.

By way of example, the multi-layer structure may be configured to filter particles from the airflow having a relatively small particle size compared to those filtered by the additional fibre layer.

The additional fibre layer may be arranged upstream of the multi-layer structure.

The additional fibre layer may further comprise an electrostatic enhancing additive or coating.

The electrostatic enhancing additive may be a coating on a surface of one or more of the multi-layer structure, the second, membrane layer, the third fibre layer (24a) or the additional fibre layer which is presented to the airflow.

The multi-layer structure may comprise an additive having at least one of hydrophobic, oleophobic or omniphobic properties.

It may be beneficial for the first fibre layer or the second membrane layer to comprise a hydrophobic, oleophobic or omniphobic additive.

For example, the oleophobic additive may be applied to a surface of the first fibre layer which is presented to the airflow.

Depending on the application, hydrophobic, oleophobic, or omniphobic properties can benefit the

[symbol]

In some embodiments, the multi-layer structure may form a pleated structure.

The pleated structure may be of frusto-conical, cylindrical, split-cylindrical or flat panel form.

The biodegradable filter assembly may comprise an adhesive for adhering the filter medium to the filter frame, wherein the adhesive comprises a biodegradable polymer.

If present in the embodiment, one or more of the multi-layer structure, the second, membrane layer, the third fibre layer or the additional fibre layer may be provided with an electrostatic enhancing additive.

For example, the electrostatic enhancing additive is a coating on a surface of one or more of the multi-layer structure, the second, membrane layer, the third fibre layer or the additional fibre layer which is presented to the airflow.

In some embodiments, the multi-layer structure may comprise an additive having at least one of hydrophobic, oleophobic or omniphobic properties.

The first fibre layer or the second membrane layer may comprise a hydrophobic, oleophobic or omniphobic additive.

The inclusion of an omniphobic additive, for example, either within the fibres or as a coating on top of the upstream surface of the fibre layer, will enable the filter assembly to repel water and oils and may provide an additional benefit over a hydrophobic additive only. Depending on the application, it may be preferable to use a hydrophobic additive or an oleophobic additive. This may have the effect of enhancing the service life of the filter assembly.

The use of a hydrophobic or omniphobic additive may reduce absorption of humidity or dense moisture in the air into the fibres, and may also reduce drying time for the filter assembly.

By way of example, an oleophobic additive may be applied to a surface of the first fibre layer which is presented to the airflow.

The multi-layer structure may form a pleated structure. The pleated structure may be of frusto-conical, cylindrical, split-cylindrical or flat panel form. The pleated structure presents an increased surface area to the incoming airflow.

The filter assembly may comprise an adhesive for adhering the filter medium to the filter frame. For example, the adhesive may comprise a biodegradable polymer.

In some embodiments, the biodegradeable filter may be a biodegradable part of an air purification system.

In this case, the biodegradeable filter may further comprise an activated carbon filter arranged downstream of the multi-layer structure for filtering gasses from the airflow.

According to a second aspect of the invention, there is provided an electrical appliance comprising the biodegradable filter assembly of the first aspect.

The electrical appliance may be an air purification system, such as a standing air purification system. Alternatively, the air purification system may form a part of a wearable purification system.

In other embodiments the electrical appliance may be a dust separation device forming part of a vacuum cleaner.

Another aspect of the invention relates to a vacuum cleaner including a dust separation device having a biodegradeable filter of the first aspect of the invention.

It will be appreciated that preferred and/or optional features of any one aspect of the invention may be incorporated alone or in appropriate combination in other aspects of the invention also.

### BRIEF DESCRIPTION OF DRAWINGS

The present invention will now be described, by way of example only, with reference to the following figures in which:

FIG. 1 is a perspective view of a wearable air purifier with which a filter assembly of the present invention may be used;

FIG. 2 is a schematic representation of a filter medium for use in the filter assembly of the wearable air purifier in FIG. 1;

FIG. 3 is a perspective view of the filter medium in FIG. 2;

FIG. 4 is a front view of the filter medium in FIG. 3 with the direction of airflow indicated upstream of the filter medium;

FIG. 5 is a front cross-section view of the filter medium in FIG. 4, with the direction of airflow indicated downstream of the filter medium;

FIG. 6 is an exploded, perspective view of the filter medium in FIGS. 2 to 5 to illustrate components of a frame for the filter medium;

FIG. 7 is an exploded, front view of the filter assembly in FIG. 6;

FIG. 8 a cross section of the exploded, front view of the filter assembly in FIG. 7;

FIG. 9 shows a schematic diagram to show the contact angle for a surface treated with a hydrophobic material;

FIG. 10a is a front view of a surface-standing (domestic) purifier with which a filter assembly of another embodiment of the invention may be used; and

FIG. 10b is a side view of the surface-standing (domestic) purifier in FIG. 10a.

### DETAILED DESCRIPTION

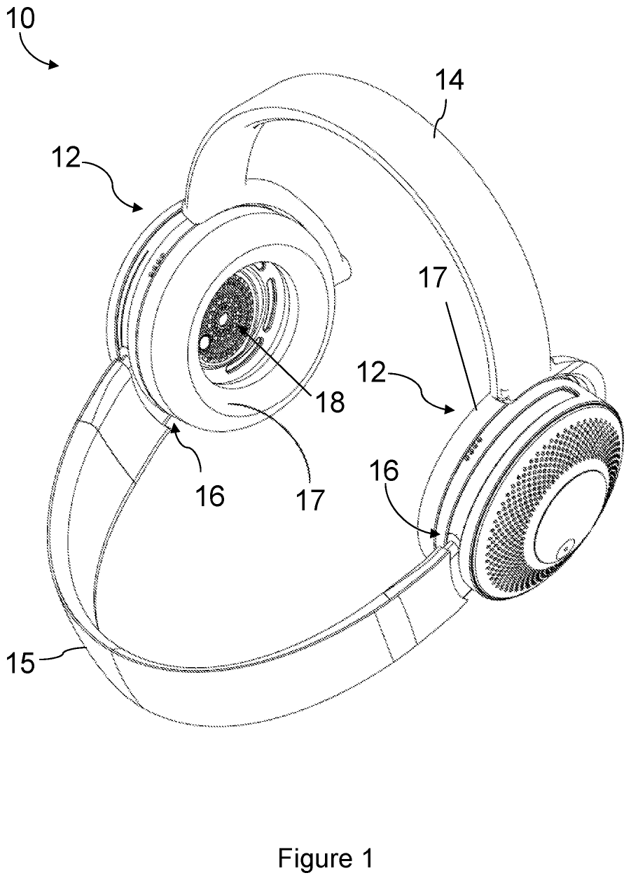

FIG. 1 shows a portable device in the form of a wearable air purifier 10. The head wearable air purifier 10 comprises a pair of generally head-mounted cylindrical speaker assemblies 12 connected by an arcuate headband 14, and a visor 15 that extends between and is connected at opposite ends to both speaker assemblies 12. Each of the pair of speaker assemblies 12 comprises an air inlet (not identified) and an air outlet or discharge port 16, a speaker or driver unit (not identified) within the housing, and an earpad 17 arranged to enclose the speaker 12 and to encompass or press against an ear of a user.

Inside its housing, each of the pair of speaker assemblies 12 further comprises a filter assembly 18 (identified on one of the speaker assemblies), an impeller for creating an airflow through the filter assembly and a motor arranged to drive the impeller. The impeller is a mixed flow impeller that has a generally conical or frusto-conical shape and both the impeller and the motor are disposed within an impeller casing that is generally frusto-conical in shape. The speaker assembly has a speaker driver nested behind the impeller, which is behind the filter.

The air outlet or discharge port is downstream (i.e. relative to the airflow generated by the impeller) from the filter assembly 18 and is arranged to emit the filtered/purified airflow from the speaker assembly 12. In the illustrated embodiment, the air outlet or discharge port 16 of each speaker assembly 12 is provided in a side of the speaker assembly 12, with the air outlet or discharge port 16 of both speaker assemblies 12 being connected to the nozzle or visor 15. In use, the speaker assemblies 12 are positioned on the user's ears, the headband 14 on top of the user's head and the visor 15 in front of the user's mouth. Air outlets provided at the mouth facing side of the visor 15 blow the filtered and purified air towards and into the user's mouth, thereby allowing the user to breath in air that is considerably cleaner than the ambient air of their direct environment.

In other embodiments of the wearable air purifier the speaker assemblies need not be present and instead the device may just take the form of a purifier system having the impeller, the motor and the filter. The wearable device 10 takes the same overall form as that shown in FIG. 1, except that the speaker components are removed and just the a filter device is provided on each side of the device, together with the impeller/motor arrangement. Air that is drawn into the device via the impeller/motor arrangement is filtered of particulate matter and other contaminants within the airflow as it passes through the filter 18 and the purified air is blown towards the wearer's mouth.

Further details of the wearable air purifier shown in FIG. 1 can be found in the Applicant's co-pending patent applications GB2575814A and WO2020021231A1.

The filter assembly of the wearable purifier is a high efficiency particulate filter which is intended to collect particles within the size range between 0.1 μm and 3.0 μm, and with at least 99% efficiency for both salt (NaCl) and oil/paraffin particles (referred to as DOP or DEHS) at a face velocity of no more than 7 m/s, and typically around 6.2 cm/s. The restriction (dP) of this media at this face velocity is less than 200 Pa.

Whilst the filter assembly of the invention provides a beneficial filtration performance with high efficiency, in accordance with the aforementioned definition, it also provides the advantage of being biodegradable by virtue of the composition of the filter medium, and of the structural components of the filter frame or housing. The biodegradable nature of the filter assembly ensures that, when the filter assembly reaches the end of its life and is discarded, it does not contribute detrimentally to landfill and/or other environmental pollutants which are associated with the disposal of known filter arrangements. The combination of a high efficiency filter assembly, with a prolonged service life, and with a structure in which all elements have a high bio-based content, provides significant benefits across many fields of appliance, including air purification systems and floor care appliances.

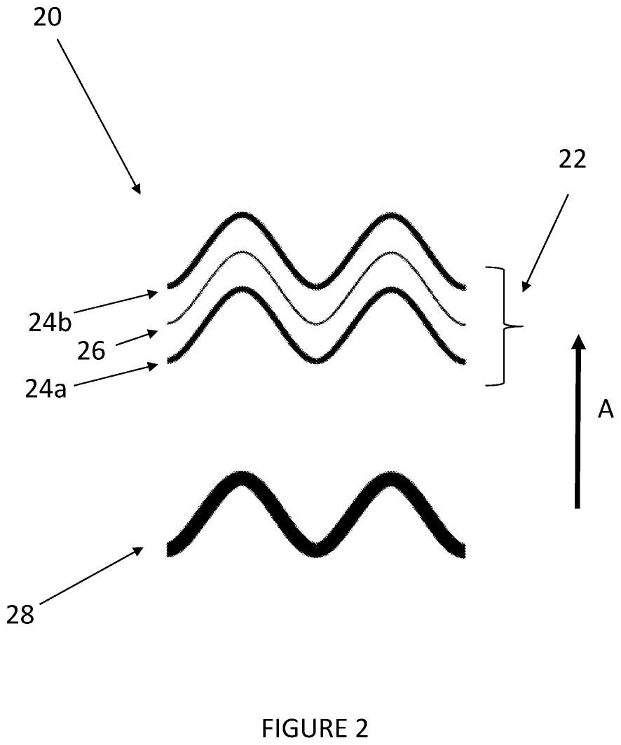

FIG. 2 is a schematic illustration of the filter medium 20 of a filter assembly in accordance with a first embodiment of the invention. The filter medium 20 includes a multi-layer structure in the form of a sandwich layer structure 22 comprising first and second layers, 24a, 24b respectively, of non-woven, and a third, thinner fibre electro spun layer 26 (membrane layer) sandwiched between them. Manufacturing options for the non woven layers 24a, 24b include but are not limited to; meltblowing, spunbond methods, centrifugal spinning or calendaring. In production, layers 24a or 24b may be used as a substrate for the membrane layer 26 to be electrospun onto. Alternatively, the electrospun layer 26 and the non woven layers 24a, 24b are together combined to form a single structure which defines sandwich structure. The electrospun layer 26 may or may not carry a residual electrostatic charge from manufacture which is of benefit to the layers filtration performance. The first non woven layer is a lower layer 24a of the sandwich structure and the second layer 24b is an upper non woven layer of the sandwich structure. The upstream non woven layer 24a (as denoted by the Arrow A) or the sandwich structure 22 may be electrostatically treated to aid filtration performance. The overall sandwich layer structure 22 meets the requirements described previously for particulate capture.

In other embodiments, the layers 24a, 24b, or the structure 22 need not be electro-statically charged, as will be described in further detail below. In addition to the sandwich layer structure 22, the filter member includes a further non-woven layer in the form of a meltblown fibre layer 28, which meets the same high collection efficiency parameters. The meltblown fibre layer 28 forms a fleece layer which has a thickness greater than that of the combined sandwich layer structure 22.

In the embodiment shown the meltblown fibre layer 28 is placed adjacent to the sandwich layer structure 22 but is displaced from the sandwich layer structure by an air gap of up to 1 mm. The fibre layer 28 may, alternatively, be bonded to the sandwich layer structure 22 so that the air gap is not present. Placing the fibre layer 28 upstream of the sandwich layer structure 22 (as denoted by the Arrow A) has advantages, although in practice the fibre layer 28 may be placed either upstream or downstream of the sandwich layer structure 22. The presence of the meltblown fibre layer 28 has been shown to increase the service life of the overall filter by capturing larger particles before reaching the membrane layer 26

As shown in FIG. 2, the combined layers of the sandwich layer structure 22 and the fibre layer 28 are pleated or corrugated to maximise the filtration area available to the airflow. The pleated arrangement of the meltblown fibre layer 28 is consistent with that of the sandwich layer structure 22. However, equally all layers 24a, 24b, 26, 28 may be flat, or one layer (e.g. the sandwich layer structure 22) may be pleated or corrugated) and the other layer (e.g. the meltblown fibre layer 28) may be flat. In order for the corrugation to be applied, it is essential that the upper electrospun layer 24b is present to provide protection for the membrane layer 26. The lower layer 24a is important in any arrangement as it provides essential support for the thin membrane layer 26.

In some embodiments, the sandwich layer structure 22 need not include all three filter layers and instead only a pair of layers may be used, including a base non woven layer (lower layer 24a, optionally formed as a spunbond layer) and the electrospun nanofibre membrane layer 26 on top. For example, this arrangement may be more suitable for use in a domestic or surface-mounted purifier, as described in further detail below. Here, the structure 22 may take the form of a repeated structure of such pairs of layers (e.g. 24a, 26, 24a, 26, 24a, 26 etc.). For example, in another embodiment, the multi-layer structure 22 may take the form of a lower non woven layer 24a plus a membrane layer 26, and then another pair of layers 24a, 26, and then a final top layer 24b to enable corrugation of the multi-layer structure 22. In other embodiments there may be more than two pairs of layers 24a, 26, followed by the optional top, non woven layer 24b. In these embodiments, the layer 28 of FIG. 2 is not present.

The fibre diameters of layers 24a and 24b are typically between 20-50 μm, and for layer 26 much smaller nanofibers of 100-500 nm.

The elements of the sandwich layer structure 22 may be bonded together using a non-microbial toxic, compostable chemical binder, or using an ultrasonic method to fuse the layers 24a, 26, 24b together. Once the sandwich layer structure 22 is formed it may be combined or co-pleated with the fibre layer 28 using a similar bonding method to the sandwich layer structure 22.

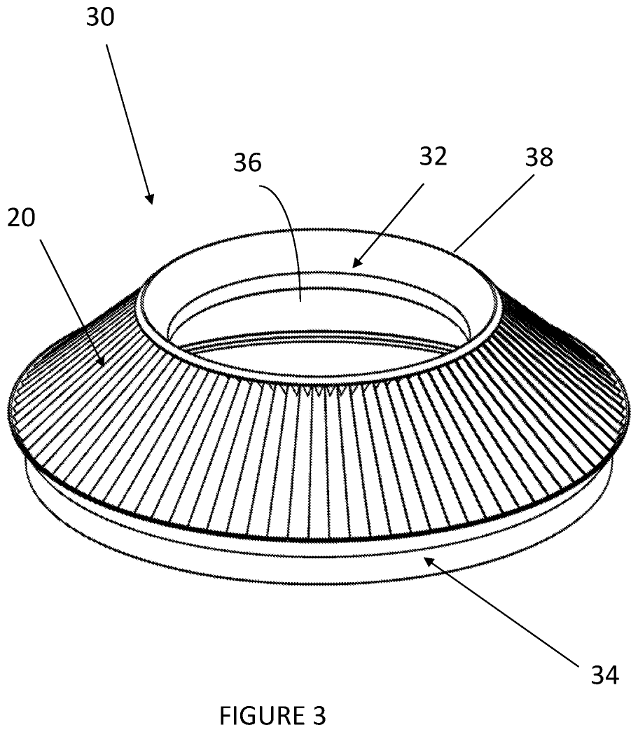

Referring to FIG. 3, the pleated arrangement of the filter medium 20 can be seen clearly in the perspective view of a filter assembly 30. The filter medium is supported on a frame having an upper annular support 32 at the upper end of the filter assembly (upper in the orientation shown) and a lower annular support 34 at the lower end of the filter assembly.

The filter medium 20 is arranged in a frusto-conical shape which defines an open central passage 36. The frusto-conical shape is suitable for use in a filter assembly for a wearable purifier, such as that shown in FIG. 1. The central passage 36 defines a central opening at the upper end or neck 38 of the filter medium 20 which has a smaller diameter than the central opening at the lower end.

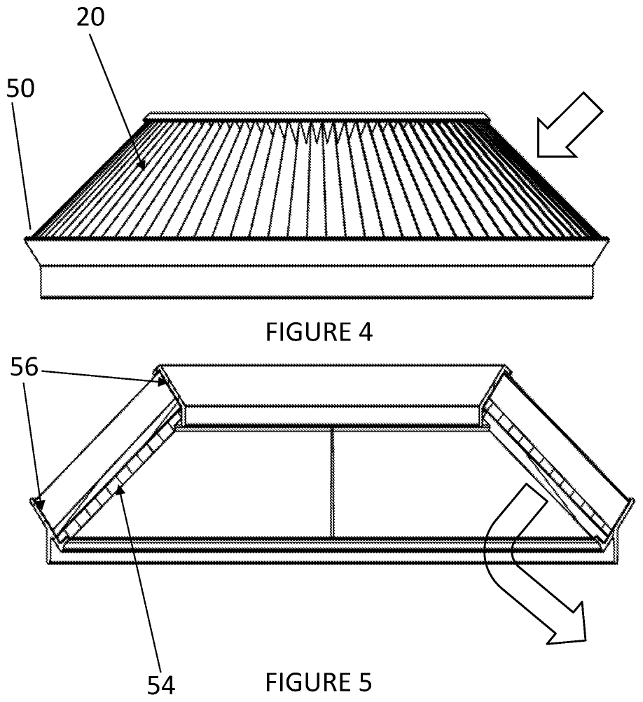

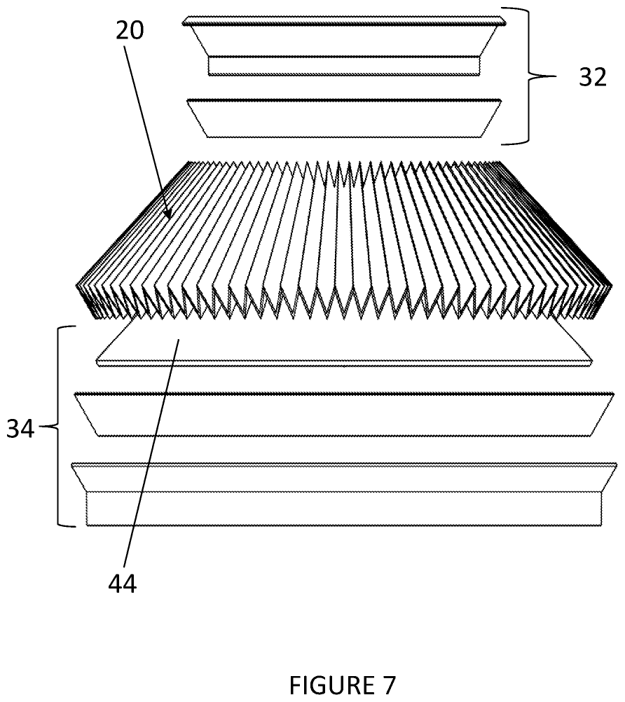

Referring also to FIGS. 4 to 8, the upper annular support 32 includes a support element 40 which supports the neck 38 of the filter medium 20 at its upper end. A layer of hot glue (modelled as item 42) is applied to the support element 40. The lower annular support 34 is formed from two concentrically arranged support elements 44, 48 which together support the lower end of the filter medium 20. A layer of hot glue (modelled as item 46) is applied to the support element 48. The hot glue layers 42, 46 serve to bond the support elements 40, 44, 48 to the filter medium 20, and together the upper and lower annular supports 32, 34 form a frame for the filter medium 20. The lower end of the frusto-conical filter medium 20 defines a skirt 50 defined around a lip on the upper support element 44 of the lower annular support 34, the skirt projecting beyond the rim of the upper support element 44. The lower support element 48 of the lower annular support 34 receives the intermediate support element 46, which in turn receives the upper support element 44, and together the three support elements 44, 46, 48 provide a rigid lower support structure for the filter medium 20.

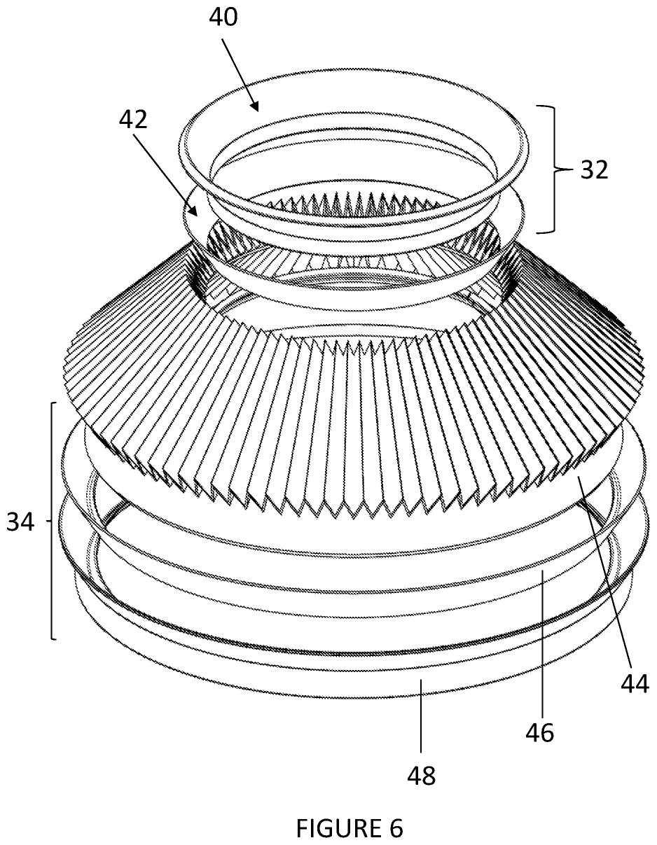

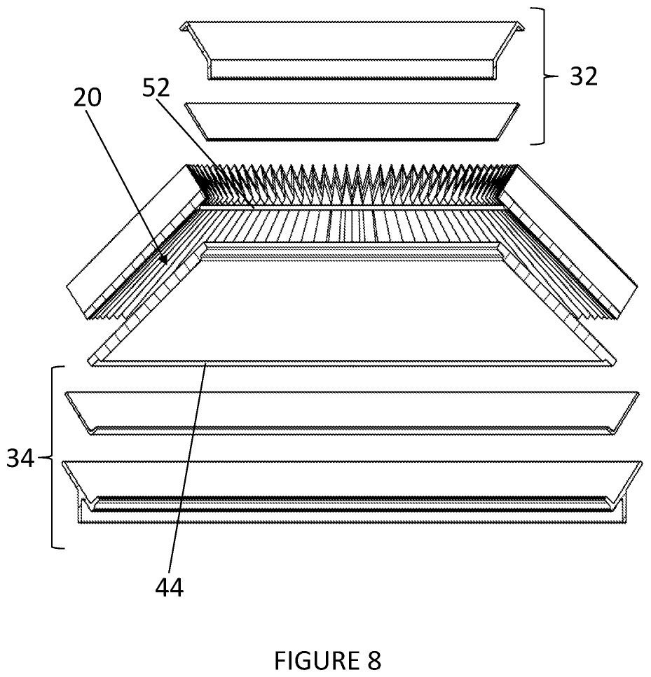

The hotmelt glue or potting 42, 46 is used to retain the pitch of the pleated filter medium (corrugation distance) and is made from a biodegradable polymer such as polycaprolactone (PCL), PHA (polyhydroxyalkanoates) or PLA (polylactide) or a blend thereof using at least 25% biodegradable polymer. A thin layer of potting or hotmelt glue 56 (as seen in FIG. 5 and FIG. 8) is also used to seal the filter medium 20 to the frame, at both the upper and lower ends of the filter assembly, and is also made from a biodegradable polymer such as polycaprolactone (PCL), PHA (polyhydroxyalkanoates) or PLA (polylactide) or a blend thereof using at least 25% biodegradable polymer. Natural waxes may also be used in the glue composition.

As seen in FIG. 5, the upper support element 44 of the lower annular support 34 carries an activated carbon filter 54 which defines a further filter medium through which the airflow through the filter assembly passes. The carbon filter 54 is of frusto-conical form and is located downstream of the sandwich layer structure 22 and removes gasses from the airflow. A scrim, which is a very thin layer (not shown), secures the carbon filter in place and is made from a starch-based polymer like polylactic acid which is produced as a spunbond. In practice, this scrim may be the same PLA spunbond layer 24a, 24b onto which the membrane layer 26 may be electrospun.

The material properties of the constituent parts of the filter assembly mean that, importantly, the filter assembly is biodegradable, which provides significant advantages for disposal of the filter assembly at the end of it service life. The materials of the filter medium 20, which enable efficient filtration across a range of smaller and larger particles, and ensure biodegradability, will now be described in further detail.

The fibre layer 28 may be formed from an electrostatically charged, meltblown non-woven fibre material. These materials are typically more efficient in capturing particles larger than 0.2 μm, whereas membrane filters, such as the fibre layer 26, have a better capturing efficiency for particles smaller than 0.2 μm. This means that the combination of the sandwich layer structure 22 incorporating the membrane layer 26, together with the fibre layer 28, creates a filter medium which has a greater capture efficiency across a full range of small and large particles, typically between 0.1 and 0.3 μm. Furthermore, arranging the fibre layer 28 upstream of the sandwich layer structure 22 ensures that the fibre layer 28 will act like a fleece or pre-filter, capturing oil particles and increasing the filtration time before the membrane filter 22 becomes saturated. The lower fibre layer 24a therefore defines the upstream face of the filter assembly.

The layers of the sandwich layer structure 22 and the fibre layer 28 each comprise at least 90% starch-based polymers, such as polylactic acid. At the end of their service lives, these materials biodegrade into water and carbon dioxide through an industrial aerobic or anaerobic composting process. This conversion is initiated through hydrolysis whilst in the presence of high moisture compost (around 50-60% moisture (water) of the compost by weight), microbes and at temperatures of around 55° C. The filter frame 32, 34 is made from at least 90% starch-based polymers such as polylactic acid which again has biodegradable benefits.

The fibre layers 24a, 24b of the sandwich structure 22 and the additional fibre layer 28 may be formed through the process including but not limited to electrospinning or centrifugal spinning, by spunbond methods or by meltblowing.

In order to enhance the service life of the filter assembly, the fibre layers 24a, 24b of the sandwich structure 22 may be provided with an additive material having hydrophobic properties (a hydrophobic material is one which tends to repel water). Examples of treatments which may be applied to the fibre layers 24a, 24b to provide the required hydrophobic property include plasma treatments, surface patterning (sometimes referred to as the lotus leaf effect), chemical treatment with an additive to alter surface energy (for example, fluorination) or direct impregnation of the fibres with surface active chemicals. A combination of one or more treatments is also possible. The fibre layers 24a, 24b may be treated, coated, developed or otherwise changed so as to change the surface chemistry of the layer to be hydrophobic.

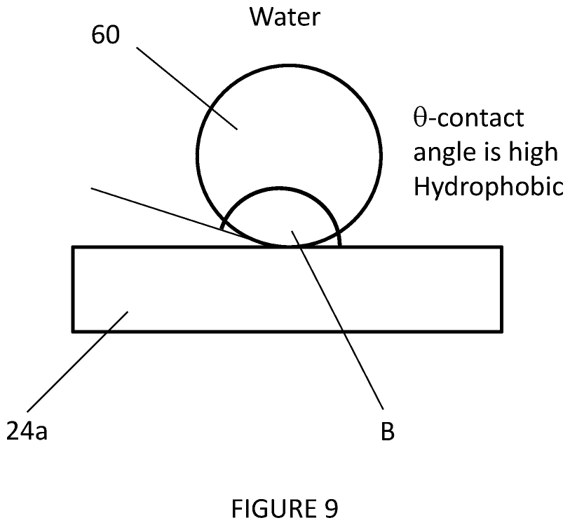

FIG. 9 illustrates the upstream surface of a layer 24a (i.e. that surface of the layer 24a which faces the incoming airflow) having hydrophobic properties with a droplet of water 60 making contact with the surface of the layer 24a. A hydrophobic material is defined as one in which the angle of contact B of the water droplet 60 with the contact surface is relatively high (above 90 degrees). In the example illustration shown the contact angle B for the water droplet is around 140 degrees.

The hydrophobic material may be included as a coating to the fibre layer 24a or may be formed within the fibre structure itself, as an additive as opposed to a coating. Including the additive within the fibre structure is beneficial as all faces of the non-woven fibre layer 24a will have enhanced performance, as opposed to spraying on the surface only, and so the very small pores are less likely to be blocked.

Hydrophobic properties are also beneficial as they reduce the absorption of humidity or dense moisture in the air into the fibres. The biodegradable starch-based polymers from which the non-woven fibre layer 24a is formed, such as polylactic acid, are inherently hydrophilic and because of the large surface area of the nano and micro fibre diameters, they are prone to swelling in size after exposure to moisture. This behaviour has a tendency to increase the restriction of the filter medium and subsequent power draw of the downstream system. Applying a hydrophobic additive or treatment to the fibre layer 24a will reduce the rate at which these fibres increase in size, increasing usable life and reducing cost to the user. It also enables this filter to be viable in more humid locations and geographies.

The treatment of the fibre layer 24a with a hydrophobic additive also has the effect of altering the water retention characteristics of the layer so that, when the filter structure is washed, the transfer of water away from the surface of the treated fibre layer through drying enables the dried state of the layer to be reached more quickly than it would otherwise for an untreated filter layer. When the filter medium is removed and washed for servicing, this benefits the drying time of the medium and provide advantages to the user when the filter is serviced

Importantly, the hydrophobic additive which is applied to the fibre layer 24a must not hinder the filtration of the airflow whilst dust particulates which are carried in the airflow are prevented from passing through the layer. The resistance to airflow through the fibre layer 24a must also be unaffected by the treatment that is applied.

As an alternative to applying the additive to the layers 24a, 24b, the additive may be applied to the structure 22 (e.g. by coating) once the layers have been bonded together.

In further embodiments, the fibre layer 24a is treated with an oleophobic additive which repels oils (in the same way as a hydrophobic additive repels water). The illustration in FIG. 9 is applicable to an oleophobic material also, with the contact angle B above 90 degrees. The oleophobic additive may be provided as a coating on the upstream surface of the fibre layer 24a, or may for an integral part of the fibre structure of the fibre layer. The inclusion of the oleophobic additive, either within the fibres or as a coating on top of the upstream surface of the fibre layer 24a, will enable the filter to repel oils.

In still further embodiments the fibre layer 24a is treated with an omniphobic additive, as opposed to a mere hydrophobic one. An omniphobic material is one which repels oil as well as water (and repels any liquid) and the illustration in FIG. 9 is applicable to an omniphobic material also, with the contact angle B above 90 degrees. The omniphobic additive may be provided as a coating on the upstream surface of the fibre layer 24a, or may form an integral part of the fibre structure of the fibre layer. The inclusion of the omniphobic additive, either within the fibres or as a coating on top of the upstream surface of the fibre layer 24a, will enable the filter to repel water and oils and provided additional benefit over a hydrophobic additive only, as discussed below.

Because the sandwich layer structure 22 has a flat, almost two-dimensional structure it differs from the non-woven fibre layer 28, which is a fleece layer of greater depth. This means that when oil particles come into contact with the sandwich layer structure 22 they can conglomerate and block the very fine pores of the thin fibre layer 26. Hence, it is beneficial if oil particles bead away from each other and reduce blinding over and blockages of the filter medium. By providing the fibre layer 24a with oleophobic properties, there is a tendency for the increase in air restriction to reduce over time, thus reducing the energy draw of the mechanical system downstream. It will also inherently extend the usable life of the filter assembly, reducing cost to the user and number of filters which need to be disposed of.

Both layers 24a, 24b of the sandwich layer structure 22 may be treated with a hydrophobic additive, an oleophobic additive, or an omniphobic additive to provide the advantages mentioned above.

In addition, the thicker fibre layer 28 may also be treated with an oleophobic, hydrophobic or omniphobic additive.

Examples of omniphobic additives include, but are not limited to, fluorine modified epoxy polymers for example biobased epoxidized material obtained from cardanol, i.e. NC-514. These coatings will also have oleophobic properties. Examples of hydrophobic additives include but are not limited to; silica, titania, perfluoroalkyl and polyfluoroalkyl substances (PFAS).

Having a balance of the hydrophobic additives in the filter medium 20 may be important. Too much of the hydrophobic additive may reduce the rate at which hydrolysis of the filter medium 20 can incur when in compost at the end of service life. Although it is unlikely to stop the biodegradation process, it may take longer than desired for meeting standard requirements if the hydrophobicity is too high. Hence, there is a delicate balance between the requirement for the hydrophobic additive to the face of the fibre layer 24a to provide service life benefit, and the requirement for the filter medium 20 to be biodegradable.

If PLA (polylactide) is used for the thicker meltblown fibre layer 28, the material may naturally be able to take on charge without the need for electrostatic enhancing additives.

Forming meltblown non-woven fibre layers is a standard process whereby melted polymer (such as polylactic acid) is extruded through very small nozzles at a high flow rate with air blown over the surface. These micron diameter fibres are deposited on top of each other in a non-uniform structure. Whilst cooling at the end of the production line, the non-woven layer is passed through a corona-discharged field to electrostatically charge the PLA or other polymer fibres. A corona-discharge field could also be applied to the structure of 22 or its sub layers.

In other embodiments, omniphobic, hydrophobic, oleophobic additives or electrostatic enhancing additives can be compounded with starch-based polymers to enhance the dielectric charge holding capacity to increase the electrostatic forces of the thicker meltblown fibre layer 28, or the polymers used to make the layers of 22. This enables the same filter medium 20 or layer 28 to retain its charge for longer and have a greater collection efficiency. As smaller particles have a lesser mass than larger ones, they are more likely to be attracted due to the greater electrostatic force. These smaller particles are typically a challenge to capture in conventional non-woven filter media.

The electro-static enhancing additives may be applied together with the omniphobic, hydrophobic or oleophobic additives, or on their own, and may be applied to either the membrane layer 26 and/or the fibre layer 28.

If a carbon filter is provided (feature 54—FIG. 5), the activated carbon chips are not intended to compost, as it does not contain sugars for the microbes to digest. However, if the carbon content is small enough in dimension (typically less than 2 mm) and quantity, it will pass composting international requirements (such as the standard, EN-13432 or ASTM-D6400). The addition of the carbon filter 54 therefore does not prohibit the complete filter assembly from meeting the required standards.

The filter frame is made from at least 90% starch based polymers such as polylactic acid. The hotmelt glue to retain the pleat pitch (corrugation distance) or potting to seal the filter medium 20 to the frame 32, 34 is made from a biodegradable polymer such as polycaprolactone (PCL), or a blend thereof using at least 25% PCL. The hot melt glue has a Shore hardness (Shore A scale) which is typically no more than 80, but could be higher. The whole construction of the filter assembly, including the filter frame, the hotmelt and the filter medium, is therefore one which is readily biodegradable, whilst filtration performance is achieved across both smaller (less than 0.2 μm diameter) and larger (greater than 0.2 μm diameter) by virtue of the combined sandwich structure 22 and meltblown fibre layer 28.

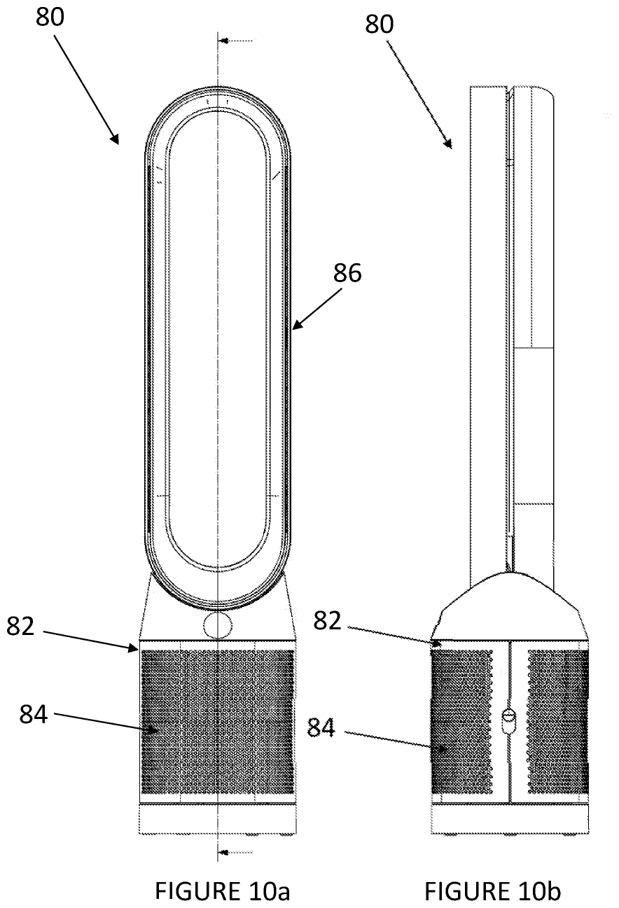

Although the invention has been described in the context of a wearable air purifier, the filter assembly is equally applicable to domestic or surface-standing air purifiers such as the one shown in FIGS. 10a and 10b. The surface-standing purifier, referred to generally as 80, is configured to generate and deliver an airflow for the purpose of thermal comfort and/or environmental or climate control. The assembly may be capable of generating a dehumidified airflow, a humidified airflow, a filtered airflow, a cooled airflow, a heated airflow, and/or a purified airflow. A main body 82 of the purifier is provided with an inlet (not identified) through which a primary airflow enters the body, a removable filter assembly 84 mounted on the body over the inlet, and a nozzle 86 by which means the filtered airflow exits the body. The nozzle 86 comprises one or more outlets and an interior passage for conveying air from the air inlet of the nozzle to the air outlets (not identified). The filter assembly 84 has the construction described previously, being a biodegradeable filter assembly. The surface-mounted purifier may be of the type described, for example, in the Applicant's co-pending International patent application WO 2019/106332.

In the case of the surface-mounted purifier, the filter assembly is a high efficiency particulate filter which is intended to collect airborne particles of all sizes, but most numerously in the range between 0.1 μm and 3.0 μm, and with at least 99.95% efficiency (i.e. with greater efficiency than for a wearable filter). Surface-standing purifiers typically do not incorporate electro-statically charged layers.

For domestic or surface-standing purifiers, the service life of the filter is longer and so some markets have legislation which can require that electro static charging/additives cannot be used. This is because the charge may degrade over time, to a point where the filter has a much lower efficiency compared to its start of life. For domestic or surface-standing purifiers, the efficiency of filtration can be achieved without the use of electrostatic charging (although they can be used in some embodiments). Wearable filters have a much shorter service life and so electrostatic charging can be used. For example, referring back to FIG. 2, the fibre layer 28 (which in the wearable purifier may be formed from an electrostatically charged, meltblown non-woven fibre material) need not be included in a filter assembly for a domestic or surface-standing purifier.

In a domestic or surface-standing purifier, the filter assembly also takes a different form to the frusto-conical section shown in FIGS. 3 to 8. Typically, for example, the filter assembly is of cylindrical or split cylindrical form. Other shapes are also envisaged depending on the particular application, including flat panel filters.

The invention is also applicable to electrical appliances in the form of vacuum cleaners where the requirement to dispose of the filter assembly at the end of life can pose problems. In addition, the benefit for such filters to have a prolonged life can be enhanced through the use of additives on or within the structure of the fibre layers, and high efficiency of performances can be achieved through the aforementioned fibre structures and the combination of the sandwich structure 22 and the meltblown layer 28.

A vacuum cleaner typically comprises a main body which is equipped with a suction motor, a dust separator, and a cleaner head connected to the dust separator usually by a separable coupling. The dust separator is the main mechanism by which the vacuum cleaner removes dirt and debris from the airflow through the machine, and this applies whether the dust separator relies on a cyclonic separation system or otherwise. It is important that the suction motor is protected from this dirt and debris which can be potentially damaging to some of its components. It is also important to make the exhaust airflow that is discharged from the vacuum cleaner as clean as possible so that the user is not breathing in harmful fine particulates from the vacuum. It is therefore known to house a pre-motor filter medium (or “pre-filter”) in the airflow through the machine downstream of the dust separator but upstream of the suction motor, and a post-motor filter (or “post-filter”) that is located in the airflow downstream of the suction motor, before the airflow exhausts from the machine. Sometimes the pre-filter is mounted in a common unit with the post-filter and the unit can be removed easily by the user for cleaning purposes. Once the filter assembly is removed from the appliance, the pre-filter can be washed, and dried, and the filter assembly is then replaced in the appliance. At the end of life, the filter assembly needs to be disposed of.

The characteristics of the filter medium described previously with reference to the air purification system, are equally beneficial when employed within a vacuum cleaner application. In particular, a filter assembly for a vacuum clean having both pre-filter and post-filter filter elements benefits from having the filter medium and the filter frame being comprised of at least 80% bio-based materials and in accordance with the subject matter of the accompanying claims.

The carbon filter feature described previously is a useful feature of the filter assembly when used in air purification system, but this feature may not be required for floor care appliances.

It will be appreciated that various alternative embodiments to those described previously are also envisaged without departing from the scope of the appended claims.

1. A biodegradable filter assembly for an electrical appliance comprising a motor for generating an airflow through the appliance, in use, the biodegradable filter assembly being configured to filter particulate matter from the airflow, wherein the biodegradable filter assembly comprises a filter medium and a filter frame for the filter medium, wherein both the filter frame and the filter medium comprise at least 80% bio-based polymers which are compostable at the end of filter assembly service life.

2. The biodegradable filter assembly as claimed in claim 1, wherein the filter medium comprises a multi-layer structure comprising a first, fibre layer and a second, membrane layer carried by the first fibre layer, and wherein the multi-layer structure comprises at least 80% bio-based polymers.

3. The biodegradable filter assembly as claimed in claim 2, wherein the filter medium comprises a plurality of multi layer structures each comprising a first, fibre layer and a second, membrane layer carried by the first fibre layer.

4. The biodegradable filter assembly as claimed in claim 2, wherein the multi-layer structure comprises at least one further fibre layer to define a sandwich layer structure, with the membrane layer sandwiched between the first and further fibre layers, and wherein the further fibre layer comprises at least 80% bio-based polymers.

5. The biodegradable filter assembly as claimed in claim 4, wherein the fibre structure comprises at least one further membrane layer carried by one of the first fibre layer or the further fibre layer, and wherein the further membrane layer comprises at least 80% bio-based polymers.

6. The biodegradable filter assembly as claimed in claim 2, wherein layers of the multi-layer structure are bonded together with a compostable chemical binder.

7. The biodegradable filter assembly as claimed in claim 6, wherein the layers of the multi-layer structure are thermally bonded together.

8. The biodegradable filter assembly as claimed in claim 2, further comprising an additional fibre layer.

9. The biodegradable filter assembly as claimed in claim 8, wherein the additional fibre layer is thicker than the multi-layer structure.

10. The biodegradable filter assembly as claimed in claim 9, wherein the additional fibre layer and the multi-layer structure are bonded together with a compostable chemical binder.

11. The biodegradable filter assembly as claimed in claim 8, wherein the multi-layer structure is configured to filter particles from the airflow having a relatively small particle size compared to those filtered by the additional fibre layer.

12. The biodegradable filter assembly as claimed in claim 8, wherein the additional fibre layer is arranged upstream of the multi-layer structure.

13. The biodegradable filter assembly as claimed claim 8, wherein one or more of the multi-layer structure, the second, membrane layer, the third fibre layer or the additional fibre layer are provided with an electrostatic enhancing additive.

14. The biodegradable filter assembly as claimed in claim 13, wherein the electrostatic enhancing additive is a coating on a surface of one or more of the multi-layer structure, the second, membrane laye, the third fibre layer or the additional fibre layer which is presented to the airflow.

15. The biodegradable filter assembly as claimed in claim 2, wherein the multi-layer structure comprises an additive having at least one of hydrophobic, oleophobic or omniphobic properties.

16. The biodegradable filter assembly as claimed in claim 15, wherein the first fibre layer or the second membrane layer comprises a hydrophobic, oleophobic or omniphobic additive.

17. The biodegradable filter assembly as claimed in claim 16, wherein an oleophobic additive is applied to a surface of the first fibre layer which is presented to the airflow.

18. The biodegradable filter assembly as claimed in claim 2, wherein the multi-layer structure forms a pleated structure.

19. The biodegradable filter assembly as claimed in claim 18, comprising an adhesive for adhering the filter medium to the filter frame, wherein the adhesive comprises a biodegradable polymer.

20. The biodegradable filter assembly as claimed in claim 1, wherein the biodegradable filter assembly forms part of an air purification system.

21. The biodegradable filter assembly as claimed in claim 2, wherein the biodegradable filter assembly forms part of an air purification system and further comprises an activated carbon filter arranged downstream of the multi-layer structure for filtering gasses from the airflow.

22. An electrical appliance comprising the biodegradable filter assembly as claimed in claim 1.

23. The electrical appliance as claimed in claim 22, wherein the electrical applicance comprises an air purification device.
